(19) United States
(12) Patent Application Publication
(10) Pub. No.: US 2023/0364889 A1
(43) Pub. Date: Nov. 16, 2023

(54) LAMINATED GLAZING

(71) Applicant: Pilkington Group Limited, Nr. Ormskirk Lancashire (GB)

(72) Inventors: Ashley Carl TORR, Lancashire (GB); James ECKHART, Lambertville, MI (US)

(73) Assignee: Pilkington Group Limited, Nr. Ormskirk Lancashire (GB)

(21) Appl. No.: 18/246,955

(22) PCT Filed: Sep. 27, 2021
(86) PCT No.: PCT/GB2021/052506

§ 371 Date: Mar. 28, 2023

Related U.S. Application Data
(60) Provisional application No. 63/084,165, filed on Sep. 28, 2020.

(51) Int. Cl. B32B 17/10; G01S 7/481

(52) U.S. Cl. CPC B32B 17/10165; B32B 17/10036; B32B 17/10633; B32B 17/10568; B32B 17/10119; B32B 17/10761; B32B 17/10807; G01S 7/4813; B32B 2307/7376; B32B 2605/006

(57) ABSTRACT

A laminated glazing includes first and second sheets of glazing material joined by an interlayer structure including a first sheet of adhesive interlayer material having a first (window) region for positioning a (LIDAR) sensor thereon and a second region that is a through-vision region. The first region comprises a first portion and the second region comprises a second portion of a major surface of the first sheet of glazing material. The laminated glazing has a first transmittance of electromagnetic radiation transmitted by the sensor at the first portion that is higher than a second transmittance at the second portion. It also has a visible light transmission greater than 70% at the second portion. The separation of the first and second glazing material sheets varies in at least one direction and/or the first sheet of adhesive comprises heat absorbing particles such as lanthanum hexaboride particles or certain metal-doped metal oxide particles.

The present invention relates to a laminated glazing for use with a sensor, in particular a vehicle windscreen having a LIDAR sensor coupled therewith.

The use of a laminated glazing for a vehicle windscreen is well known. Such a laminated glazing typically comprises two sheets (often referred to as “plies” or “panes”) of soda-lime-silicate glass joined by a sheet of polyvinyl butyral (PVB). Each glass sheet may be 2.1 mm thick and the PVB sheet is typically 0.76 mm thick. One of the two sheets of glass is usually referred to as the inner sheet and the other sheet of glass is usually referred to as the outer sheet. Defining the glass sheets in this way relates to the position of the respective glass sheet when the laminated glazing is installed in the vehicle.

Head up display (HUD) systems for vehicles are also well known. Typically a HUD has four basic parts, (i) a source of light, for displaying information to be shown to the driver of the vehicle, (ii) an electronic part comprising a microprocessor to process data and provide the information to be visualised, (iii) an optical system which carries the beam of light and focusses the image at a certain distance from the eyes of the driver, and (iv) a combiner which superimposes the image of the driving information on that of the outer environment.

It is known to use the windscreen of a vehicle as the combiner. A light source is configured for projection onto the inner facing surface of the windscreen (i.e. the surface facing the interior of the cabin of the vehicle) to be projected into the line of sight of the vehicle driver.

WO 2010/035031A1 describes a laminated glazing for use as windscreen with a HUD. An example is provided with two curved plies of glass each having a thickness of 1.8 mm, tinted light green in colour with a light transmission (CIE Illuminant A) of 80%. A PVB interlayer is used to bond the two glass plies together to produce the laminate, the PVB interlayer being pre-shaped and unshaped fully and partially wedged.

It is well known that the use of wedged PVB in HUD systems for vehicle windscreens can reduce the amount of “ghosting” (or secondary image) that the driver of the vehicle observes. Such ghosting is due to the HUD light source being reflected from the air/glass interface at the inner surface of the windscreen to produce a primary image to be observed by the vehicle driver, and HUD light that is transmitted through the windscreen is reflected off the glass/air interface (the outer surface of the windscreen), also back towards the driver of the vehicle to produce a secondary image viewable by the vehicle drive, but slightly offset from the primary image. The wedged interlayer i.e. PVB reduces the spacing between the primary image and the secondary image, see for example U.S. Pat. No. 5,013,134.

The use of sensors incorporated into a vehicle windscreen is also known in the art. The sensor may be mounted on the surface of the windscreen facing the vehicle interior to emit a sensing beam through the windscreen. The sensing beam may be used to provide the driver of the vehicle with additional information about the road ahead. One such sensor is a LIDAR which uses a method for measuring distances (ranging) by illuminating a target with laser light and measuring the reflection with a sensor. As is known in the art, LIDAR is used as an acronym of “Light Detection and Ranging”.

More recently LIDAR sensors has become integrated with a vehicle windscreen, see for example WO 2008/1849093A1 and WO 2020/025360A1.

Incorporating a sensor such as a LIDAR into a vehicle windscreen presents a number of challenges. One particular challenge is that in order for the sensor achieve better or optimal performance, the vehicle windscreen is required to have certain ultraviolet and/or visible and/or infrared properties that are not necessarily commensurate with the desired ultraviolet and/or visible and/or infrared properties required to provide the vehicle windscreen with a desired solar performance. This is further complicated when the vehicle windscreen is to be used as a combiner in a HUD because the sensor is operable by emitting a sensing beam out of the vehicle windscreen, whereas the HUD utilises light reflected from a surface of the vehicle windscreen facing the vehicle interior.

Furthermore, it is desired that the method of manufacture of such a vehicle windscreen should be relatively simple and also able to be easily modified in the event a windscreen having the same shape and solar performance is to be used in a vehicle that does not have a HUD or a sensor such as a LIDAR.

The present invention aims to at least partially overcome the problems discussed above.

Accordingly, the present invention provides from a first aspect a laminated glazing comprising a first sheet of glazing material joined to a second sheet of glazing material by an interlayer structure therebetween, the interlayer structure comprising at least a first sheet of adhesive interlayer material, each of the first and second sheets of glazing material having a respective first major surface and second opposing major surface; the laminated glazing being arranged such that the second major surface of the first sheet of glazing material faces the first major surface of the second sheet of glazing; the laminated glazing having a first region for a window for a sensor and a second region being a through-vision region, the first region of the laminated glazing comprising a first portion of the first major surface of the first sheet of glazing material and the second region of the laminated glazing comprising a second portion of the first major surface of the first sheet of glazing material; the sensor being arranged to transmit a beam of electromagnetic radiation having at least a first wavelength towards the first portion of the first major surface of the first sheet of glazing material for transmission through the laminated glazing and out of the second major surface of the second sheet of glazing material; wherein at normal incidence to the first portion of the first major surface of the first sheet of glazing material, the laminated glazing has a first transmittance at the first wavelength and at normal incidence to the second portion of the first major surface of the first sheet of glazing material, the laminated glazing has a second transmittance at the first wavelength, the first transmittance of the laminated glazing being higher than the second transmittance of the laminated glazing; and wherein at normal incidence to the second portion of the first major surface of the first sheet of glazing material, the second region of the laminated glazing has a visible light transmission (CIE Illuminant A) of greater than 70%; further wherein the separation of the first major surface of first sheet of glazing material and the second major surface of the second sheet of glazing material in at least the second region of the laminated glazing varies in at least a first direction, and/or wherein the first sheet of adhesive interlayer material comprises heat absorbing particles selected from the list consisting of aluminium-doped tin oxide particles, gallium-doped zinc oxide particles (GZO particles), indium-doped zinc oxide particles (IZO particles), aluminium-doped zinc oxide particles (AZO particles), niobium-doped titanium oxide particles, sodium-doped tungsten oxide particles, caesium-doped tungsten oxide particles (CWO particles), thallium-doped tungsten oxide particles, rubidium-doped tungsten oxide particles, tin-doped zinc oxide particles and silicon-doped zinc oxide particles, lanthanum hexaboride (LaB₆) particles, metal-doped tungsten oxide particles.

Opposite the first portion of the first major surface of the first sheet of glazing material is a first portion of the second major surface of the first sheet of glazing material.

If the laminated glazing is used as a combiner in a head up display, at least a portion of the second region may be used for reflection of a beam of light from a HUD light source.

If the laminated glazing is used as a combiner in a head up display, by having the separation of the first major surface of first sheet of glazing material and the second major surface of the second sheet of glazing material to vary in at least the second region of the laminated glazing, the laminated glazing is configured to reduce the intensity of a double image that may be produced as a HUD light source illuminates the inner facing surface of the laminated glazing. This may conveniently be achieved by using a wedged interlayer structure such that the laminated glazing has non-parallel surfaces, the wedged interlayer structure being thicker in an upper region compared to a lower region (wherein upper refers to the position of the laminated glazing when installed in a vehicle).

The preferred heat absorbing particles are lanthanum hexaboride (LaB₆) particles and/or metal-doped tungsten oxide particles, in particular caesium doped tungsten oxide particles (CWO particles).

Preferably the first sheet of glazing material comprises less than 0.1% by weight Fe₂O₃.

Preferably the second sheet of glazing material comprises less than 0.1% by weight Fe₂O₃.

Preferably the sensor comprises a LIDAR.

Preferably the first wavelength is between 750 nm and 1650 nm, more preferably between 750 nm and 1050 nm or between 1500 nm and 1600 nm.

Preferably the sensor is operable at two or more wavelengths. Preferably at least two of the two or more wavelengths are between 750 nm and 1650 nm, more preferably between 750 nm and 1050 nm or between 1500 nm and 1600 nm.

Preferably the first sheet of adhesive interlayer material is monolithic.

Preferably the first sheet of adhesive interlayer material has a multi-layer construction.

Preferably the first sheet of adhesive interlayer material is wedge shaped.

Preferably the interlayer structure is wedge shaped.

Preferably the first sheet of adhesive interlayer material comprises polyvinyl butyral (PVB), ethylene vinyl acetate (EVA), poly vinyl chloride (PVC), polyurethane (PU), acoustic modified PVB or Uvekol® (a liquid curable acrylic resin).

Preferably the first sheet of adhesive interlayer material has a thickness between 0.3 mm and 2.3 mm, more preferably between 0.3 mm and 1.6 mm, most preferably between 0.3 mm and 0.85 mm.

Preferably the interlayer structure has a thickness between 0.3 mm and 2.3 mm, more preferably between 0.3 mm and 1.6 mm, most preferably between 0.3 mm and 0.85 mm.

Preferably the first and/or second sheet of glazing material has a thickness less than 5 mm.

Preferably the first and/or second sheet of glazing material has a thickness greater than 0.3 mm.

Preferably the first and/or second sheet of glazing material has a thickness between 0.4 mm and 3 mm.

Preferably the first and/or second sheet of glazing material comprises glass, more preferably soda-lime-silica glass. A typical soda-lime-silica glass composition is (by weight), SiO₂ 69-74%; Al₂O₃ 0-3%; Na₂O 10-16%; K₂O 0-5%; MgO 0-6%; CaO 5-14%; SO₃ 0-2%.

Preferably the first and/or second sheet of glazing material comprises chemically strengthened glass.

Preferably the first transmittance is greater than 80%, more preferably greater than 85%, even more preferably greater than 90%.

Preferably the interlayer structure comprises the first sheet of adhesive interlayer material and at least a second sheet of interlayer material. The second sheet of interlayer material may be adhesive or non-adhesive. If the second sheet of interlayer material is non-adhesive, at least one major surface of the second sheet of interlayer material may be provided with an adhesive material.

Preferably the interlayer structure comprises the first sheet of adhesive interlayer material spaced apart from at least a second sheet of adhesive interlayer material by at least one sheet of non-adhesive interlayer material, in particular a sheet of polyester such as polyethylene terephthalate (PET).

Preferably the interlayer structure has less than twenty sheets of adhesive interlayer material, more preferably less than ten sheets of adhesive interlayer material, even more preferably less than five sheets of adhesive interlayer material.

Preferably the interlayer structure has only one sheet of adhesive interlayer material or only two sheets of adhesive interlayer material or only three sheets of adhesive interlayer material.

Preferably the laminated glazing is curved in at least one direction. Preferably the radius of curvature in the at least one direction is between 500 mm and 20000 mm, more preferably between 1000 mm and 8000 mm.

Preferably average particle diameter of the heat absorbing particles is 0.01 μm or more, more preferably 0.02 μm or more, preferably 0.1 μm or less, and more preferably 0.05 μm or less. When the average particle diameter is not less than the above lower limit, the heat ray shielding properties are sufficiently enhanced. When the average particle diameter is not more than the above upper limit, the dispersibility of heat shielding particles is enhanced.

The “average particle diameter” refers to the volume average particle diameter. The average particle diameter can be measured using a particle size distribution measuring apparatus such as “UPA-EX150” available from NIKKISO CO., LTD.

Preferably the content of the heat absorbing particles in the first sheet of adhesive interlayer material is 0.01% by weight or more, more preferably 0.1% by weight or more, even more preferably 1% by weight or more, further preferably 1.5% by weight or more.

Preferably the content of the heat absorbing particles in the first sheet of adhesive interlayer material is 6% by weight or less, more preferably 5.5% by weight or less, even more preferably 4% by weight or less, even more preferably 3.5% by weight or less, and most preferably 3.0% by weight or less.

When the content of the heat shielding particles is not less than the above lower limit and not more than the above upper limit, the heat shielding properties are sufficiently enhanced and the visible light transmittance is sufficiently enhanced.

When the laminated glazing is installed in a vehicle, preferably the first direction is substantially parallel to the vertical.

In embodiments where the interlayer structure includes the first sheet of adhesive interlayer material and a second sheet of non-adhesive interlayer material, preferably the second sheet of interlayer material comprises a plastic material such as a polyester i.e. PET, or polycarbonate, or the second sheet of interlayer material comprises glass, in particular soda-lime-silica glass.

In such embodiments, the second sheet of interlayer material has first and second opposing major surfaces and preferably at least one of the first and second major surfaces of the second sheet of interlayer material is provided with an adhesive, such as a pressure sensitive adhesive or curable adhesive.

In embodiments where the interlayer structure includes a first sheet of adhesive interlayer material and a second sheet of adhesive interlayer material, preferably the second sheet of adhesive interlayer material comprises polyvinyl butyral (PVB), ethylene vinyl acetate (EVA), poly vinyl chloride (PVC), polyurethane (PU), acoustic modified PVB or Uvekol® (a liquid curable acrylic resin).

In embodiments where the first sheet of adhesive interlayer material is multi-layered, it is preferred that the first sheet of adhesive interlayer material comprises a first layer and a second layer, the first layer having a higher hardness than the second layer.

Preferably the first sheet of adhesive interlayer comprises three layers, wherein the second layer is between the first layer and a third layer. Preferably the third layer is the same material as the first layer.

Preferably at least one of the first and second layers, and when present the third layer, has a wedge shaped thickness profile.

Preferably the first layer, and when present the third layer, comprises polyvinyl butyral or polyethylene terephthalate.

Preferably the second layer comprises a polyvinyl butyral modified material, an ethylene vinyl acetate copolymer, a vinyl chloride resin material, a silicone resin material, or similar material.

Preferably the first and/or second layer comprises heat absorbing particles.

When present, preferably the third layer comprises heat absorbing particles.

In some embodiments first and/or second sheet of glazing material contains between 0.001% and 0.07% by weight Fe₂O₃.

In such embodiments the first and/or second sheet of glazing material preferably comprises glass, preferably soda-lime-silica glass.

When Fe₂O₃ is present in a glass, it can exist in two oxidation states, namely ferrous iron (Fe²⁺) and ferric iron (Fe³⁺). The total iron oxide Fe₂O₃ content of a glass is usually quoted in terms of Fe₂O₃ only, and the ratio of ferrous iron to ferric iron is quoted as a percentage of the total Fe₂O₃.

It is possible to determine ferrous iron by chemical techniques, although for low iron containing glass, the level of ferrous iron is low making other techniques more suitable. One such technique is to measure the absorption of the glass at 1000 nm, as this is in the region of the peak absorption due to ferrous iron. It is then possible to determine the ferrous iron content using the well-known Lambert-beer law and an appropriate extinction coefficient for ferrous iron. A method of optically determining the amount of ratio of ferrous iron to ferric iron in glass is described by C. R. Bamford in “Colour Control and Generation in Glass”, Elsevier (1977).

Preferably the percentage of ferrous iron expressed as Fe₂O₃ is less than 20% of the total Fe₂O₃.

Preferably the percentage of ferrous iron expressed as Fe₂O₃ is greater than 5% of the total Fe₂O₃.

The amount of ferrous iron may be lowered by using oxidising agents such as ceria (CeO₂) or sodium nitrate in the glass making batch.

In some embodiments the first and/or second sheet of glazing material is wedge shaped.

In some embodiments the first portion of the first major surface of the first sheet of glazing material comprises an anti-reflective coating thereon.

Preferably the anti-reflective coating covers the entire first portion of the first major surface of the first sheet of glazing material.

Preferably the anti-reflective coating covers at least a part of the second portion of the first major surface of the first sheet of glazing material.

Preferably the anti-reflective coating covers the entire second portion of the first major surface of the first sheet of glazing material.

Preferably the anti-reflective coating increases the first transmittance and/or transmittance at normal incidence to the first portion of the first sheet of glazing material at one or more wavelength.

In some embodiments having an anti-reflective coating on the first portion of the first major surface of the first sheet of glazing material, the first transmittance is increased by at least 1%, preferably by at least 2%.

Preferably the first transmittance is between 80% and 95%.

In some embodiments at normal incidence to the second portion of the first major surface of the first sheet of glazing material, the second region of the laminated glazing has a total transmitted solar (TTS %) measured using ISO 13837:2008 Convention A (with outside surface wind velocity v₁ of approximately 4 m/s) of less than 65%, more preferably less than 60%, even more preferably less than 55%, even more preferably less than 50%.

In some embodiments at normal incidence to the first portion of the first major surface of the first sheet of glazing material, the first region of the laminated glazing has a visible light transmission (CIE Illuminant A) greater than the visible light transmission (CIE Illuminant A) of the second region of the laminated glazing when measured at normal incidence to the second portion of the first major surface of the first sheet of glazing material.

In some embodiments at normal incidence to the first portion of the first major surface of the first sheet of glazing material, the first region of the laminated glazing has a visible light transmission (CIE Illuminant A) greater than 75%, preferably greater than 80%, more preferably greater than 85%, even more preferably greater than 90%. In some embodiments where the first sheet adhesive interlayer material comprises an opening therein and a second sheet of adhesive interlayer material is positioned in the opening in the first sheet of adhesive interlayer material, preferably the first sheet of adhesive interlayer material comprises heat absorbing particles and the second sheet of adhesive interlayer material does not comprise heat absorbing particles.

In some embodiments where the first sheet adhesive interlayer material comprises an opening therein and a second sheet of adhesive interlayer material is positioned in the opening in the first sheet of adhesive interlayer material, preferably the first sheet of adhesive interlayer material comprises polyvinyl butyral (PVB), ethylene vinyl acetate (EVA), poly vinyl chloride (PVC), polyurethane (PU), acoustic modified PVB or Uvekol® (a liquid curable acrylic resin) and the second sheet of adhesive interlayer material comprises polyvinyl butyral (PVB), ethylene vinyl acetate (EVA), poly vinyl chloride (PVC), polyurethane (PU), acoustic modified PVB or Uvekol® (a liquid curable acrylic resin).

Preferably the first and second sheets of adhesive interlayer material both comprise EVA, PU or PVB.

In some embodiments at least a portion of the first region is provided with means to prevent the formation of mist on the first portion of the first major surface of the first sheet of glazing material.

Preferably means to prevent the formation of mist on the first portion of the first major surface of the first sheet of glazing material comprises heating means. It is preferred that the incorporation of heating means does not have a negative impact on the performance of the sensor, in particular to reduce the first transmittance at the first wavelength which may affect the sensitivity of the sensor.

Preferably means to prevent the formation of mist on the first portion of the first major surface of the first sheet of glazing material comprises blower means. Suitable blower means may be provided by a fan to direct air, which may or may not be heated, towards the first portion of the first major surface of the first sheet of glazing material.

In some embodiments the first sheet of adhesive interlayer material is wedge shaped and contains heat absorbing particles selected from the list consisting aluminium-doped tin oxide particles, indium-doped tin oxide particles, antimony-doped tin oxide particles (ATO particles), gallium-doped zinc oxide particles (GZO particles), indium-doped zinc oxide particles (IZO particles), aluminium-doped zinc oxide particles (AZO particles), niobium-doped titanium oxide particles, sodium-doped tungsten oxide particles, caesium-doped tungsten oxide particles (CWO particles), thallium-doped tungsten oxide particles, rubidium-doped tungsten oxide particles, tin-doped indium oxide particles, tin-doped zinc oxide particles and silicon-doped zinc oxide particles, lanthanum hexaboride (LaB₆) particles and metal-doped tungsten oxide particles.

The present invention provides from a second aspect a method of making a laminated glazing, the laminated glazing having a first region for a window for a sensor, the sensor being operable at at least a first wavelength, the method comprising the steps: (i) providing a first sheet of glazing material and a second sheet of glazing material and an interlayer structure for positioning between the first and second sheets of glazing material, the interlayer structure comprising a first sheet of adhesive interlayer material and a second sheet of interlayer material, the second sheet of interlayer material having a higher transmittance at the first wavelength compared to the transmittance of the first sheet of adhesive interlayer material at the first wavelength; the interlayer structure having a wedge shape and/or containing heat absorbing particles, the heat absorbing particles being selected from the list consisting of aluminium-doped tin oxide particles, gallium-doped zinc oxide particles (GZO particles), indium-doped zinc oxide particles (IZO particles), aluminium-doped zinc oxide particles (AZO particles), niobium-doped titanium oxide particles, sodium-doped tungsten oxide particles, caesium-doped tungsten oxide particles (CWO particles), thallium-doped tungsten oxide particles, rubidium-doped tungsten oxide particles, tin-doped zinc oxide particles and silicon-doped zinc oxide particles, lanthanum hexaboride (LaB₆) particles, metal-doped tungsten oxide particles; (ii) arranging the interlayer structure between the first and second sheets of glazing material such that at least a portion of the second sheet of interlayer material forms part of the window for the sensor; (iii) using suitable lamination conditions to join the first sheet of glazing material to the second sheet of glazing material by the interlayer structure.

Preferably the first and/or second sheet of glazing material is a sheet of glass comprising less than 0.1% by weight Fe₂O₃.

Preferably the sensor comprises a LIDAR.

Preferably the first wavelength is between 750 nm and 1650 nm, more preferably between 750 and 1050 nm or between 1500 nm and 1600 nm.

Preferably the first sheet of adhesive interlayer material comprises polyvinyl butyral (PVB), ethylene vinyl acetate (EVA), poly vinyl chloride (PVC), polyurethane (PU), acoustic modified PVB or Uvekol (a liquid curable resin).

Preferably the first sheet of adhesive interlayer material has a thickness between 0.3 mm and 2.3 mm, more preferably between 0.3 mm and 1.6 mm, most preferably between 0.3 mm and 0.8 mm.

Preferably the first and/or second sheet of glazing material has a thickness less than 5 mm.

Preferably the first and/or second sheet of glazing material has a thickness greater than 0.3 mm.

Preferably the first and/or second sheet of glazing material has a thickness between 0.4 mm and 3 mm.

Preferably the first and/or second sheet of glazing material comprises soda-lime-silica glass. A typical soda-lime-silica glass composition is (by weight), SiO₂ 69-74%; Al₂O₃ 0-3%; Na₂O 10-16%; K₂O 0-5%; MgO 0-6%; CaO 5-14%; SO₃ 0-2%.

Preferably the first and/or second sheet of glazing material contains between 0.001% and 0.07% by weight Fe₂O₃.

In some embodiments the second sheet of interlayer material is a sheet of adhesive interlayer material.

Preferably the second sheet of adhesive interlayer material comprises polyvinyl butyral (PVB), ethylene vinyl acetate (EVA), poly vinyl chloride (PVC), polyurethane (PU), acoustic modified PVB or Uvekol (a liquid curable resin).

In some embodiments during step (ii) the interlayer structure is arranged between the first and second sheets of glazing material by making an opening in the first sheet of adhesive interlayer material and positioning the second sheet of adhesive interlayer material in or over the opening in the first sheet of adhesive interlayer material.

It is preferred that the second sheet of interlayer material is positioned in the opening in the first sheet of adhesive interlayer material and is coplanar therewith.

In some embodiments, at step (i) the interlayer structure that is provided has the second sheet of interlayer material attached to the first sheet of adhesive interlayer material.

Preferably the first sheet of adhesive interlayer material is coplanar with the second sheet of interlayer material.

In some embodiments following step (ii) a first edge of the first sheet of adhesive interlayer material is adjacent a first edge of the second sheet of interlayer material.

Preferably the first sheet of adhesive interlayer material is coplanar with the second sheet of interlayer material.

In some embodiments, at step (i) the interlayer structure that is provided has the second sheet of interlayer material positioned in an opening in the first sheet of adhesive interlayer material.

The opening has at least one edge region and the second sheet of interlayer material has at least one edge region, and the at least one edge region of the second sheet of interlayer material is in direct contact with the at least one edge region of the opening. Preferably the at least one edge region of the second sheet of interlayer material is in direct contact with and attached to the at least one edge region of the opening.

In some embodiments the first sheet of adhesive interlayer material has a first wedge angle and the second sheet of interlayer material has a second wedge angle, wherein the second wedge angle is the same or different as the first wedge angle.

In some embodiments the first sheet of adhesive interlayer material has a first wedge angle and the second sheet of interlayer material has parallel major surfaces.

The invention will now be described with reference to the following figures (not to scale) in which,

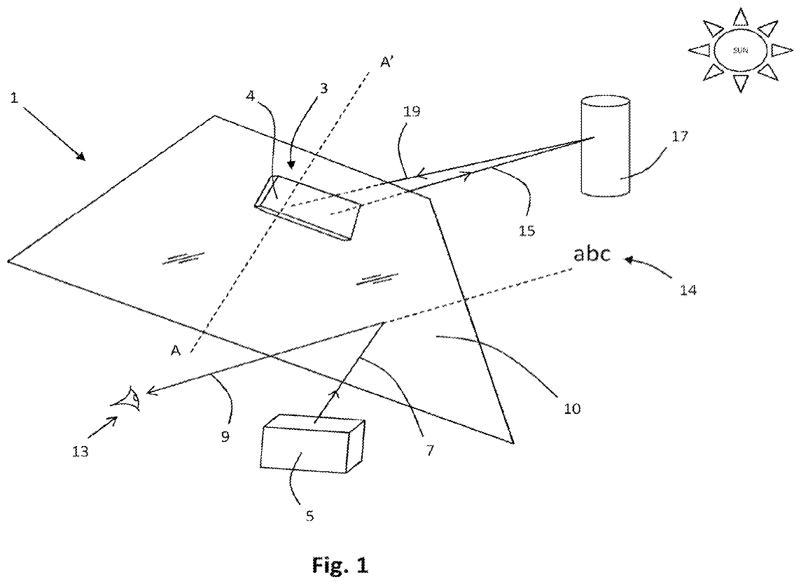

FIG. 1 shows a schematic isometric representation of a vehicle windscreen incorporating a laminated glazing according to the present invention; and

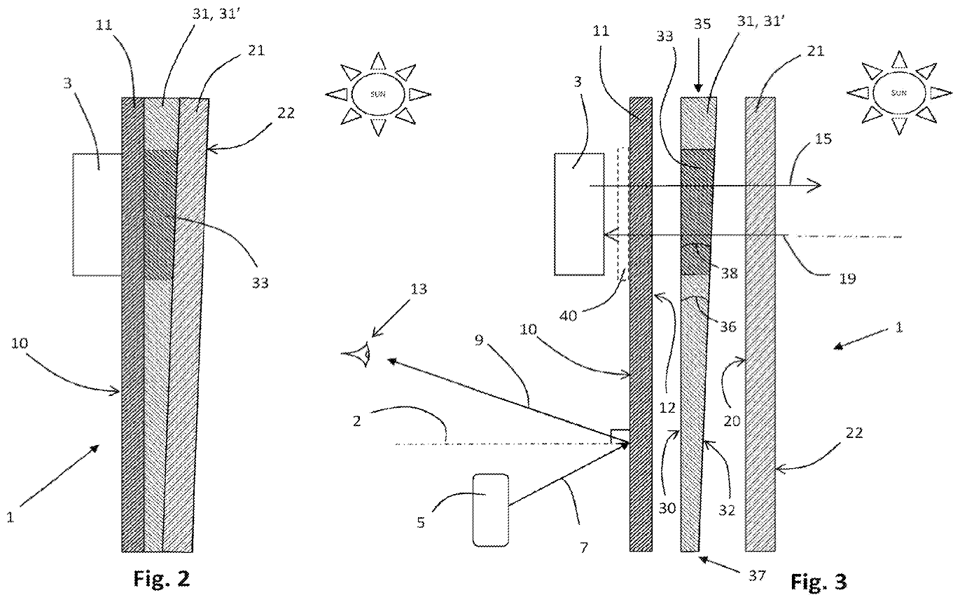

FIG. 2 shows a schematic cross-sectional view of the vehicle windscreen of FIG. 1 through the line A-A′;

FIG. 3 shows a schematic exploded cross-sectional view of the windscreen of FIG. 1 through the line A-A′ with the head up display projector included.

With reference to the figures, FIG. 1 shows a schematic isometric representation of a vehicle windscreen 1 when installed in a vehicle (not shown). The vehicle windscreen 1 has a sensor mounted on the inner facing surface 10 thereof. The sensor 3 is included in a suitable housing 4 that is suitably mounted on the inner facing surface 10. The sensor faces the inner facing surface 10 to define a first region of the windscreen 1 because this region of the windscreen acts as a window for the sensor 3. The preferred sensor 3 comprises a LIDAR. In an alternative embodiment to that shown in FIG. 1, the sensor 3 is in mechanical communication with a mount assembly (not shown), the mount being attached directly to the inner facing surface 10 of the windscreen. The mount assembly may have one or more functional element connected or mounted thereto, for example a rear view mirror or rain sensor.

The sensor 3 emits a sensing beam 15 through the vehicle windscreen 1 to strike an object 17 remote from the vehicle. A beam 19 is reflected off the object 17 to pass through the windscreen 1 for detection by the sensor 3. In this example the sensing beam 15 and the reflected beam are both infrared beams having a wavelength between 750 nm and 1650 nm, for example 905 nm.

Mounted below the vehicle windscreen 1 is a head up projector system 5. The head up projector system 5 is arranged to direct a beam of light 7 towards the inner facing surface 10 of the windscreen 1.

The beam of light 7 reflects off the inner facing surface 10 as reflected beam 9 towards an observer 13. The observer 13 sees a virtual image 14 (represented by the letters “abc”) beyond the outer surface of the vehicle windscreen 1.

The observer 13 also sees the road ahead through the windscreen 1 and this part of the windscreen acts as a window for the observer and is a second region of the windscreen 1. The second region of the windscreen 1 is a through-vision region.

With particular reference to FIGS. 2 and 3, the vehicle windscreen 1 comprises a first sheet of glass 11 joined to a second sheet of glass 21 by means of interlayer structure 31.

The first sheet of glass 11 has a first major surface 10 and an opposing second major surface 12. The second sheet of glass 21 has a first major surface 20 and an opposing second major surface 22.

The interlayer structure 31 has a first major surface 30 and an opposing second major surface 32.

The first sheet of glass 11 has a soda-lime-silica composition with an iron oxide content of 0.005% by weight expressed as Fe₂O₃. The thickness of the first sheet of glass 11 is 2.1 mm but may be in the range 1.6 mm to 5 mm.

The second sheet of glass 21 also has a soda-lime-silica composition with an iron oxide content of 0.005% by weight expressed as Fe₂O₃. The thickness of the second sheet of glass is also 2.1 mm but may be in the range 1.6 mm to 5 mm. It is preferred that the second sheet of glass 21 is thicker than the first sheet of glass 11.

The interlayer structure 31 is wedge shaped, being thicker at the upper region 35 compared to the lower region 37. As is known in the art, the use of such wedged interlayer structures is useful to reduce the double image that may occur with head up display systems as light can reflect off the air/glass interface defined by the first major surface 10 of the first sheet of glass 11 and the glass/air interface defined by the second major surface 22 of the second sheet of glass 21. In this example the wedge extends in a first direction from the upper edge of the vehicle windscreen 1 to the lower edge of the vehicle windscreen 1. When the laminated glazing 1 is installed in a vehicle, the first direction is parallel to the vertical i.e. as determined using a plumb line.

The first sheet of PVB 31′ has a wedge angle 36.

The interlayer structure 31 comprises a sheet of PVB 31′ including heat absorbing particles, the heat absorbing particles in this example caesium doped tungsten oxide particles (CWO particles). Only one composition of heat absorbing particle may be in the sheet of PVB 31′, or there may be heat absorbing particles having two or more different compositions.

In accordance with an embodiment of the present invention, the sheet of PVB 31′ has an opening therein such that the sensor 3 faces the opening. Positioned in the opening is a sheet of PVB 33 that does not contain heat absorbing particles. The sheet of PVB 33 may be sized to have the same degree of wedge as the sheet of PVB 31′. That is, the sheet of PVB has a wedge angle 38 that is same as the wedge angle 36. A suitable material for the sheet of PVB 33 is a conventional clear PVB.

Both sheets of PVB 33, 31′ may comprise other materials conventionally found in such interlayers, such as ultra-violet ray shielding agents, oxidation inhibitors, heat absorbing dyes and plasticizers.

In operation, the sensor 3 transmits the sensing beam 15 through the first sheet of glass 11, the sheet of PVB 33 and the second sheet of glass 21.

Since the sheet of PVB 33 does not contain heat absorbing particles, the infrared transparency of the sheet of PVB 33 is much higher than the infrared transparency of the sheet of PVB 31′. This ensures the sensing beam 15 and/or the reflected beam 19 are not significantly attenuated upon passing through the interlayer structure 31.

The transmittance of the laminated glazing 1 in different regions thereof at the wavelength (or wavelengths) of the sensing beam 15 may be determined using a conventional double beam spectrophotometer.

Furthermore, by using first and second glass sheets that have an iron oxide content of 0.005% by weight expressed as Fe₂O₃, the glass sheets have high transparency in the infrared region at wavelengths where the optical sensor 3 operates i.e. between 750 nm and 1650 nm.

Using a low content of iron oxide provides a convenient way to adjust the amount of ferrous iron in the first and second sheets of glass, although similar effects may be obtained using glass having higher iron content and lower ferrous iron content.

A further improvement to the transmittance through the laminated glazing 1 is to include an anti-reflection coating on the first major surface 10 of the first sheet of glass 11. Such an anti-reflection coating may be used to increase the transmittance at wavelengths at which the optical sensor 3 is operable. Suitable coatings are known in the art, see for example US 2015/0037570A1.

Such anti-reflective coatings may cover the entire first major surface 10 of the first sheet of glass 11 or a selected portion thereof. As shown in FIG. 3, an antireflective coating 40 is provided to cover at least a portion of the sheet of PVB 33 to improve transmittance at the wavelength of the sensing beam 15.

By selection of the interlayer structure 31 the vehicle windscreen 1 may have a second region thereof with a total transmitted solar (TTS %) measured using ISO 13837:2008 Convention A (with outside surface wind velocity v₁ of approximately 4 m/s) of less than 65%, preferably less than 60%, more preferably less than 55%, even more preferably less than 50%. Such a measurement may be made at normal incidence to the first major surface 10 of the first sheet of glass 11 in the same region where the head up display directs light onto the first major surface 10. Such a normal is shown as line 2 in FIG. 3.

In an alternative embodiment to that shown, the interlayer structure has parallel major surfaces (instead on non-parallel major surfaces 30, 32). The sheet of PVB 33 may be replaced by a sheet of polycarbonate or glass having a higher transmittance at the wavelength of the sensor beam compared to the transmittance of the sheet of PVB 33 at the wavelength of the sensor beam. In such an embodiment the major surface of the polycarbonate sheet or glass sheet are provided with a layer of adhesive such that the polycarbonate sheet or glass sheet can adhere to the first and second glass sheets 11, 21. Furthermore, the adhesive prevents a small gap between the major surfaces of the polycarbonate sheet or glass sheet and the first and second glass sheets. Such a small gap may act as a further interface for the passage of the sensing beam 15, thereby reducing the intensity of the sensing beam.

In another alternative embodiment, the second sheet of PVB 33 is not located in an opening in the first sheet of PVB 31′, but instead covers the entire upper region of the laminated glazing 1 (similar to how a shade band is configured, except the transmittance at the wavelength of the sensing beam is higher than the transmittance of the lower through-vision region at the wavelength of the sensing beam). In such an embodiment the first and second sheets of PVB are coplanar with edge regions aligned.

Although in the figures the laminated glazing 1 is shown as being flat, the laminated glazing may be suitably curved by bending the first and second glass sheets. Preferably the laminated glazing is curved in at least one direction. Preferably the radius of curvature in the at least one direction is between 500 mm and 20000 mm, more preferably between 1000 mm and 8000 mm.

Laminated glass samples were prepared using first and second sheets of 2.25 mm soda-lime-silica glass, each containing less than about 0.01% by weight Fe₂O₃ joined together by a sheet of adhesive interlayer material such as solar-absorbing PVB containing heat-absorbing particles such as CWO or LaB₆. The content of Fe₂O₃ in the glass sheets is sufficiently low to maintain high transmission in the 750 nm-1650 nm region (in particular between 750 nm and 1050 nm and/or between 1500 nm and 1600 nm) through the glass sheets. The content of the heat absorbing particles in the sheet of adhesive interlayer material is such that the laminated sample is provided with suitably low direct solar transmittance whilst having sufficiently high visibly light transmittance in order for the laminated glass to be used as a vehicle windscreen.

Glass sheets having such a suitably low content of Fe₂O₃ are commercially available from Pilkington Group Limited and are known as Pilkington Optiwhite™. Such glass sheets at a thickness of 2.25 mm were used to prepare the samples in Table 1 below.

Examples of sheets of such an adhesive interlayer material containing heat absorbing particles are available from Eastman Chemical Company, USA, for example the “Saflex®” type (i.e. S-Series, Q-Series), or from Sekisui Chemical Co., Ltd, Japan, as S-LEC Solar Control Film. Such sheets of adhesive interlayer material may have acoustic performance as desired and may be in wedge form.

Conventional lamination conditions were used to prepare the laminated glass samples in Table 1. The samples were each made using the same type of solar-absorbing PVB as discussed above except at a different thickness. The thickness used were 0.86 mm, 1.12 mm and 1.29 mm.

Table 1 shows the various optical properties of the three samples.

In Table 1, Illuminant A Visible Light Transmittance (%) is measured using Illuminant A according to CIE Publ. 15.2 ANSI Z26.1 in the wavelength range 380-720 nm, inclusive.

In Table 1, Direct Solar Transmittance (%) is the Direct Solar Transmittance (TDS) according to ISO 13837-2008, Parry Moon Air Mass=1.5 in the wavelength region 300-2500 nm, inclusive.

In Table 1, Direct Solar Reflectance (%) is the Direct Solar Reflectance (RDS) according to ISO 13837-2008, Parry Moon Air Mass=1.5 in the wavelength region 300-2500 nm, inclusive.

In Table 1, Total Solar Transmittance (%) is the total solar transmittance (TTS %) measured using ISO 13837-2008 Convention A (with outside surface wind velocity v₁ of approximately 4 m/s).

In Table 1, IR Solar Transmittance (%) is the IR Solar Transmittance according to ISO 13837-2008, Parry Moon Air Mass=1.5 in the wavelength region 800-2500 nm, inclusive.

In Table 1, UV Solar Transmittance (%) is the UV Solar Transmittance (TUV) according to ISO 13837-2008, Convention A in the wavelength region 300-400 nm, inclusive.

In Table 1, % T @ 880 nm is the transmittance through the sample at 880 nm.

In Table 1, Transmitted Color (L*, a*, b*) is the Transmitted Color according to CIE Publ. 15.2 ASTM Publ. 308, Illuminant D65/10° Observer.

As the data in Table 1 shows, even the thickest laminated glass sample (Sample 3) has an Illuminant A Visible Light Transmittance (%) greater than 70%.

The data for the three Samples 1, 2 and 3 are indicative of the properties that may be obtained in a sheet of solar-absorbing PVB having a wedged profile, for example having a thicker upper region having a thickness about 1.29 mm (which may be about 1.3 mm-1.4 mm), a central region having a thickness of about 1.12 mm and a lower region having a thickness of about 0.86 mm (which may be about 0.8 mm) The wedge profile may have a continuous wedge angle to go from the upper region, through the central region to the lower region. Having such a wedge profile is useful in applications where the laminated glazing is to be used as a combiner in a HUD. Typically, in the HUD region the interlayer has a thickness that varies from about 1.15 mm to about 0.95 mm to reduce double image.

In accordance with the present invention to provide the three samples with a window for a sensor such as a LIDAR, a portion of the solar-absorbing PVB was removed prior to lamination and replaced by a piece of conventional clear PVB, or other material having high transmittance at the wavelength or wavelengths at which the sensor operates. The laminated samples produced had the same properties as in Table 1 except in the region where the solar-absorbing PVB had been removed. In this region, the transmittance at the wavelength or wavelengths at which the sensor is operable was higher because the solar-absorbing PVB was not present.

The present invention has the advantage that the laminated glazing is provided with two regions having different transmittance to wavelengths at which an optical sensor is operable, thereby improving the performance of the optical sensor. The laminated glazing also may also be useful as a combiner in a head up display in a vehicle.

TABLE 1

| | | Solar | | | | | | | | | | | |
|---|---|---|---|---|---|---|---|---|---|---|---|---|---|
| | | Absorbing | | | | | | | | | | | |
| | Thickness of | PVB (with | | Illuminant | | | | | | | | | |
| | first and | CWO heat | Total | A Visible | Direct | Direct | Total | IR | | | | | |
| | second sheets | absorbing | laminated | Light | Solar | Solar | Solar | Solar | UV Solar | | | | |
| | of Pilkington | particles) | glass | Transmit- | Transmit- | Reflec- | Transmit- | Transmit- | Transmit- | | | | |
| Sample | Optiwhite | Thickness | thickness | tance | tance | tance | tance | tance | tance | % T @ | | | |
| No. | glass (mm) | (mm) | (mm) | (%) | (%) | (%) | (%) | (%) | (%) | 880 nm | L* | a* | b* |
| 1 | 2.25 | 0.86 | 5.36 | 80.86 | 49.26 | 5.73 | 61.68 | 22.89 | 0.75 | 29.31 | 92.47 | −3.51 | 0.52 |
| 2 | 2.25 | 1.12 | 5.62 | 77.62 | 43.61 | 5.71 | 57.59 | 15.2 | 0.35 | 20.45 | 91.13 | −4.49 | 0.51 |
| 3 | 2.25 | 1.29 | 5.79 | 74.96 | 39.73 | 5.4 | 54.87 | 10.63 | 0.19 | 14.62 | 90.01 | −5.3 | 0.41 |

1. A laminated glazing comprising a first sheet of glazing material joined to a second sheet of glazing material by an interlayer structure therebetween,
the interlayer structure comprising at least a first sheet of adhesive interlayer material,
each of the first and second sheets of glazing material having a respective first major surface and second opposing major surface;
the laminated glazing being arranged such that the second major surface of the first sheet of glazing material faces the first major surface of the second sheet of glazing;
the laminated glazing having a first region for positioning a sensor thereon and a second region being a through-vision region, the first region of the laminated glazing comprising a first portion of the first major surface of the first sheet of glazing material and the second region of the laminated glazing comprising a second portion of the first major surface of the first sheet of glazing material;
the sensor being arranged to transmit a beam of electromagnetic radiation having at least a first wavelength towards the first portion of the first major surface of the first sheet of glazing material for transmission through the laminated glazing and out of the second major surface of the second sheet of glazing material;
wherein at normal incidence to the first portion of the first major surface of the first sheet of glazing material, the laminated glazing has a first transmittance at the first wavelength and at normal incidence to the second portion of the first major surface of the first sheet of glazing material, the laminated glazing has a second transmittance at the first wavelength, the first transmittance of the laminated glazing being higher than the second transmittance of the laminated glazing; and
wherein at normal incidence to the second portion of the first major surface of the first sheet of glazing material, the second region of the laminated glazing has a visible light transmission (CIE Illuminant A) of greater than 70%;
further wherein
the separation of the first major surface of first sheet of glazing material and the second major surface of the second sheet of glazing material in at least the second region of the laminated glazing varies in at least a first direction, and/or
the first sheet of adhesive interlayer material comprises heat absorbing particles selected from the group consisting of aluminium-doped tin oxide particles, gallium-doped zinc oxide particles (GZO particles), indium-doped zinc oxide particles (IZO particles), aluminium-doped zinc oxide particles (AZO particles), niobium-doped titanium oxide particles, sodium-doped tungsten oxide particles, caesium-doped tungsten oxide particles (CWO particles), thallium-doped tungsten oxide particles, rubidium-doped tungsten oxide particles, tin-doped zinc oxide particles and silicon-doped zinc oxide particles, lanthanum hexaboride (LaB₆) particles, metal-doped tungsten oxide particles.

2. A laminated glazing according to claim 1, wherein the first sheet of adhesive interlayer material is wedge shaped and contains heat absorbing particles selected from the group consisting aluminium-doped tin oxide particles, indium-doped tin oxide particles, antimony-doped tin oxide particles (ATO particles), gallium-doped zinc oxide particles (GZO particles), indium-doped zinc oxide particles (IZO particles), aluminium-doped zinc oxide particles (AZO particles), niobium-doped titanium oxide particles, sodium-doped tungsten oxide particles, caesium-doped tungsten oxide particles (CWO particles), thallium-doped tungsten oxide particles, rubidium-doped tungsten oxide particles, tin-doped indium oxide particles, tin-doped zinc oxide particles and silicon-doped zinc oxide particles, lanthanum hexaboride (LaB₆) particles and metal-doped tungsten oxide particles.

3. A laminated glazing according to claim 1, wherein the first sheet of adhesive interlayer material comprises heat absorbing particles being lanthanum hexaboride (LaB₆) particles and/or metal-doped tungsten oxide particles.

4. A laminated glazing according to claim 1, wherein the first and/or second sheet of glazing material comprises less than 0.1% by weight Fe₂O₃.

5. A laminated glazing according to claim 1, wherein the sensor comprises a LIDAR.

6. A laminated glazing according to claim 1, wherein the first wavelength is between 750 nm and 1650 nm.

7. A laminated glazing according to claim 1, wherein the first sheet of adhesive interlayer material is monolithic or has a multi-layer construction.

8. A laminated glazing according to claim 1, wherein the first sheet of adhesive interlayer material and/or the interlayer structure is wedge shaped.

9. A laminated glazing according to claim 1, wherein the first sheet of adhesive interlayer material or the interlayer structure has a thickness between 0.3 mm and 2.3 mm.

10. A laminated glazing according to claim 1, wherein the first sheet of adhesive interlayer material comprises polyvinyl butyral (PVB), ethylene vinyl acetate (EVA), poly vinyl chloride (PVC), polyurethane (PU), acoustic modified PVB or a liquid curable acrylic resin.

11. A laminated glazing according to claim 1, wherein the first and/or second sheet of glazing material has a thickness less than 5 mm and/or a thickness greater than 0.3 mm.

12. A laminated glazing according to claim 1, wherein the first transmittance is greater than 80%.

13. A laminated glazing according to claim 1, wherein the first portion of the first major surface of the first sheet of glazing material comprises an anti-reflective coating thereon.

14. A laminated glazing according to claim 13, wherein the anti-reflective coating covers the entire first portion of the first major surface of the first sheet of glazing material.

15. A laminated glazing according to claim 13, wherein the anti-reflective coating covers at least a part of the second portion of the first major surface of the first sheet of glazing material.

16. A laminated glazing according to claim 13, wherein the anti-reflective coating increases the first transmittance and/or transmittance at normal incidence to the first portion of the first sheet of glazing material at one or more wavelength.

17. A laminated glazing according to claim 13, wherein the anti-reflective coating increases the first transmittance by at least 1%.

18. A laminated glazing according to claim 13, wherein the first transmittance is between 80% and 95%.

19. A laminated glazing according to claim 1, wherein at normal incidence to the second portion of the first major surface of the first sheet of glazing material, the second region of the laminated glazing has a total transmitted solar (TTS %) measured using ISO 13837:2008 Convention A (with outside surface wind velocity v₁ of approximately 4 m/s) of less than 65%.

20. A laminated glazing according to claim 1, wherein at normal incidence to the first portion of the first major surface of the first sheet of glazing material, the first region of the laminated glazing has a visible light transmission (CIE Illuminant A) greater than the visible light transmission (CIE Illuminant A) of the second region of the laminated glazing when measured at normal incidence to the second portion of the first major surface of the first sheet of glazing material.

21. A laminated glazing according to claim 1, wherein the interlayer structure facing at least part of a first portion of the second major surface of the first sheet of glazing material, the first portion of the second major surface of the first sheet of glazing material being opposite the first portion of the first major surface of the first sheet of glazing material, comprises a second sheet of interlayer material different to the first sheet of adhesive interlayer material such that the first sheet of adhesive interlayer material is part of the second region and the second sheet of interlayer material is part of the first region and wherein the second sheet of interlayer material having a higher transmittance at the first wavelength compared to the transmittance at the first wavelength of the first sheet of adhesive interlayer material.

22. A laminated glazing according to claim 21, wherein the second sheet of interlayer material is positioned in an opening in the first sheet of adhesive interlayer material.

23. A laminated glazing according to claim 21, wherein the second sheet of interlayer material has first and second opposing major surfaces, the first major surface of the second sheet of interlayer material facing the first sheet of glazing material and the second major surface of the second sheet of interlayer material facing the second sheet of glazing material and wherein the first and/or second major surface of the second sheet of interlayer material is provided with an adhesive.

24. A laminated glazing according to claim 21, wherein the second sheet of interlayer material is an adhesive sheet of interlayer material.

25. A method of making a laminated glazing, the laminated glazing having a first region for a window for a sensor, the sensor being operable at at least a first wavelength, the method comprising:
(i) providing a first sheet of glazing material and a second sheet of glazing material and an interlayer structure for positioning between the first and second sheets of glazing material,
the interlayer structure comprising a first sheet of adhesive interlayer material and a second sheet of interlayer material,
the second sheet of interlayer material having a higher transmittance at the first wavelength compared to the transmittance of the first sheet of adhesive interlayer material at the first wavelength;
the interlayer structure having a wedge shape and/or containing heat absorbing particles,
the heat absorbing particles being selected from the group consisting of aluminium-doped tin oxide particles, gallium-doped zinc oxide particles (GZO particles), indium-doped zinc oxide particles (IZO particles), aluminium-doped zinc oxide particles (AZO particles), niobium-doped titanium oxide particles, sodium-doped tungsten oxide particles, caesium-doped tungsten oxide particles (CWO particles), thallium-doped tungsten oxide particles, rubidium-doped tungsten oxide particles, tin-doped zinc oxide particles and silicon-doped zinc oxide particles, lanthanum hexaboride (LaB₆) particles, metal-doped tungsten oxide particles;
(ii) arranging the interlayer structure between the first and second sheets of glazing material such that at least a portion of the second sheet of interlayer material forms part of the window for the sensor; and
(iii) using suitable lamination conditions to join the first sheet of glazing material to the second sheet of glazing material by the interlayer structure.

26. (canceled)

27. (canceled)

28. (canceled)

29. (canceled)

30. (canceled)

31. (canceled)

32. (canceled)

33. (canceled)

34. (canceled)
